(19) United States
(12) Patent Application Publication
(10) Pub. No.: US 2020/0400066 A1
(43) Pub. Date: Dec. 24, 2020

(54) COMBUSTION ENGINE

(71) Applicant: Fernando BRIZUELA FERNANDEZ, Barakaldo - Bizkaia (ES)

(72) Inventor: Fernando BRIZUELA FERNANDEZ, Barakaldo - Bizkaia (ES)

(21) Appl. No.: 16/968,410

(22) PCT Filed: Feb. 8, 2019
(86) PCT No.: PCT/ES2019/070068

§ 371 Date: Aug. 7, 2020

(30) Foreign Application Priority Data
Feb. 9, 2018 (ES) P201830114

(51) Int. Cl. F02B 75/32; F02B 41/04

(52) U.S. Cl. CPC F02B 75/32; F01B 9/02; F02B 41/04

(57) ABSTRACT

A combustion engine is disclosed having a cylinder with a piston travelling through same, coupled by means of a piston rod to a crankshaft, wherein the piston rod has: —a first hub in its head for coupling with the crankshaft; —a second hub in its foot substantially aligned with or parallel to the first hub in the longitudinal direction of the cylinder when the crankshaft is in the upper or lower position; and —a third hub in its foot, which is offset laterally towards the front with respect to the second hub in the direction of rotation of the crankshaft; —the piston being coupled with the third hub, —having a guide for the travel of the piston rod coupled with the second hub, and —the piston being coupled with the third hub via a link rod.

### OBJECT OF THE INVENTION

The present invention relates to a combustion engine that has greater output than current combustion engines.

### BACKGROUND OF THE INVENTION

Combustion engines comprise one or more hollow cylinders in an engine block, and inside each one a piston travels in a reciprocating linear motion and, depending on the type of fuel and/or engine cycles, travels between a top dead centre (TDC) and a bottom dead centre (BDC), and wherein the piston is driven by the combustion of a mixture of air and fuel that is synchronised with the point when the piston approximately reaches the top dead centre. Given that the upper end of the cylinder is closed, it configures a closed combustion chamber wherein the expansive wave pushes the piston towards the outside of the cylinder; coupling a foot of a piston rod with said piston through a bolt, and coupling the head at the opposite end of the piston rod to the crankshaft, thereby obtaining an engine torque in the shaft of said crankshaft.

As previously mentioned, the aim is to synchronise the combustion with the point at which the piston reaches the top dead centre in the cylinder, since at that moment the compression of the mixture is greatest, the size of the combustion chamber is smallest, and the greatest output is obtained from the expansive wave. Moreover, this configuration has a drawback in that at the top dead centre, the piston rod is arranged perpendicular to the axis of the crankshaft, and the effective thrust results from the inertia of the motion the already had by the crankshaft and from the thrust of the piston rod driven by the piston, such that if the crankshaft were not in motion, it would bend or break the piston rod, since the thrust of the same would be exerted perpendicularly to the axis of the crankshaft. This configuration further implies that the torque applied to the crankshaft by the piston rod is less efficient due to the perpendicular nature of the piston rod to the axis of the crankshaft at the top dead centre, which is when the combustion is most explosive.

To minimise this negative effect, engine manufacturers, who aim to maximise the power of the mixture, try to make the explosion happen close to the TDC, in the attempt to find a compromise wherein the reduced efficiency, due to the fact that the mixture is not exploded at the TDC, is compensated by the increase in the torque applied to the crankshaft given that the piston rod has a more favourable position, but there is always a loss for one reason or another.

Furthermore, in order to maintain the piston in a substantially vertical position throughout the entire reciprocating motion, it is provided with piston skirts that are often the same height or higher than the diameter of the same. Said skirts increase the weight of the engine and engine inertia and increase the irregular wear of the cylinder due to a reciprocating motion that causes the lower edges thereof to rub against the inner walls of the cylinder with a certain torque or moment, due to the distance of said edges to the bolt that couples the piston to the piston rod.

### DESCRIPTION OF THE INVENTION

The combustion engine of the invention has a configuration that solves the aforementioned drawbacks, thereby obtaining a greater output.

The engine of the invention is of the type that comprises at least one hollow cylinder, inside of which a piston travels in a linear reciprocating motion, coupled by means of a piston rod to a crankshaft, wherein the piston rod comprises:
a first hub arranged in its head for coupling with the crankshaft,
a second hub arranged in its foot, and which is substantially aligned with or parallel to the first hub in the longitudinal direction of the cylinder when the crankshaft is in the upper or lower position, and
a third hub also arranged in the foot of the piston rod, which is offset laterally towards the front with respect to the second hub in the advance direction of the crankshaft;
the piston being coupled with the third hub to reach the top dead centre TDC when the piston rod is advanced in the direction of rotation of the crankshaft (in other words, in the projection, its head has already gone from the axis of the cylinder to in front of the axis of the crankshaft),
comprising a guide to guide the travel of the piston rod through the cylinder coupled with the second hub, and
the piston being coupled with the third hub via a link rod in order to enable clearance between the piston and the guide during the reciprocating motion.

In this manner, the top dead centre of the piston is reached when the head of the piston rod is no longer perpendicular to the axis of the crankshaft, but rather advanced a certain angle in projection with respect to the same, which generates a greater torque on the shaft of the crankshaft at the moment of combustion in said top dead centre, harnessing a greater thermodynamic power. Furthermore, the following advantages have been found in the prototypes developed:
reduction of piston weight,
reduction of consumption, by increasing output,
reduction of engine displacement needed to reach one same power of the shaft of the crankshaft.

Moreover, the tests performed have unexpectedly found a drastic reduction of CO and CO₂ emissions, beyond what was expected by a lower consumption of fuel by increasing output, surely due to the fact that greater temperatures are reached in the combustion by taking place at the optimum moment (the TDC), with an apparent improved combustion, which could possibly reduce the requirements of current vehicles with regard to the filtering of exhaust gases (which often require the implementation of post combustion valves, filters, catalysts or additives), or at least improve the ecological efficiency of the engine.

It must be mentioned that the configuration of the engine of the invention is valid for any type of engine (diesel or gasoline).

### BRIEF DESCRIPTION OF THE DRAWINGS

FIG. 1 shows a perspective view of the piston rod of a cylinder of the engine of the invention.

FIG. 2 shows a perspective view of the piston of a cylinder of the engine of the invention.

FIG. 3 shows a perspective view of the link rod of a cylinder of the engine of the invention.

FIG. 4 shows a perspective view of the guide of a cylinder of the engine of the invention and of the additional bolt by means of which it is fastened to the second hub.

FIGS. 5 to 9 show a cross section of a mounted engine cylinder of the invention in different positions of its operating cycle; specifically, FIG. 5 shows the position wherein the crankshaft is at the highest position, but wherein the piston has not yet reached the top dead centre; FIG. 6 shows the position corresponding to the bottom dead centre, wherein the crankshaft is advanced, and therefore the head of the piston rod at the moment of the combustion at the top dead centre is advanced with respect to the axis of the crankshaft, and FIG. 8 shows the piston passing through the bottom dead centre. Said figures do not show the valves or spark plugs in order to simplify the figures.

### DESCRIPTION OF A PREFERRED EMBODIMENT OF THE INVENTION

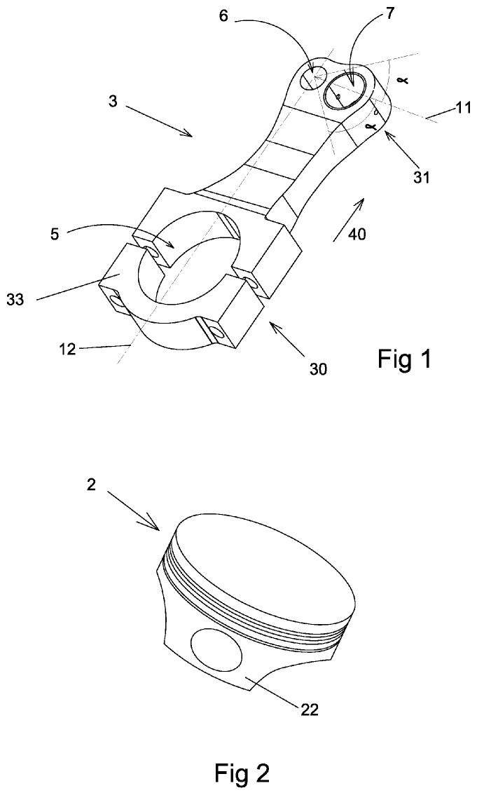

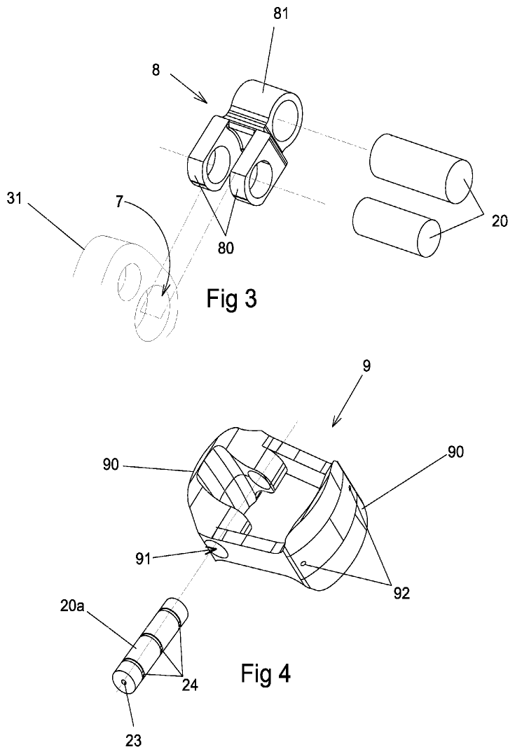

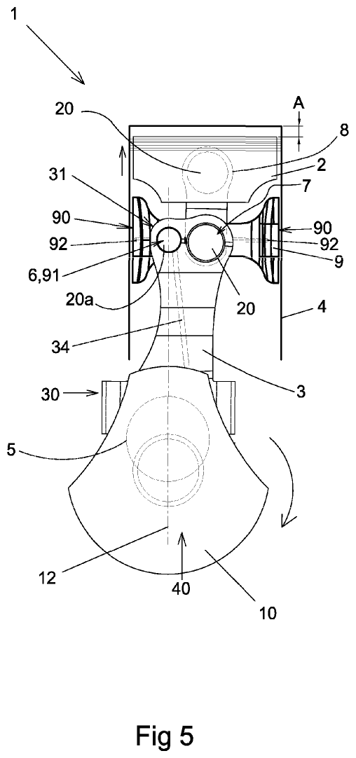

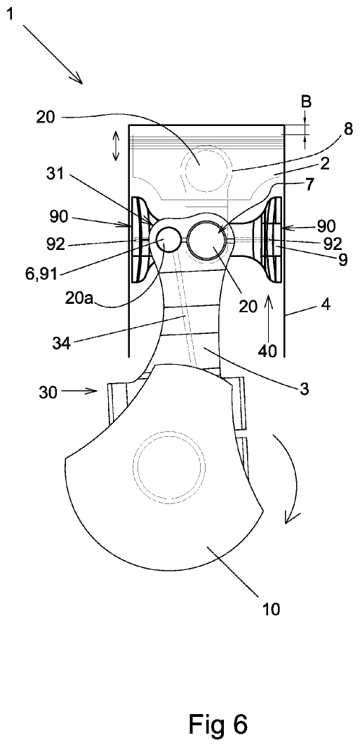

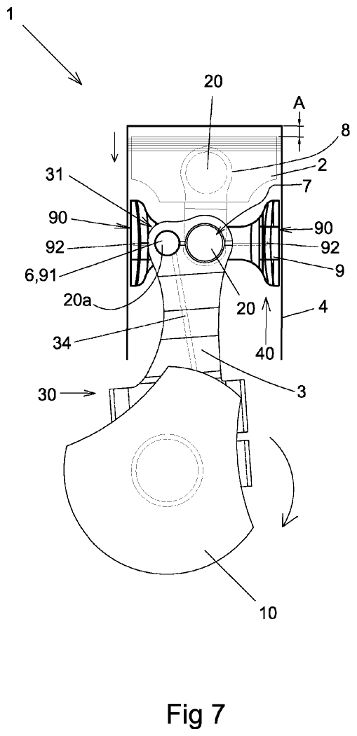

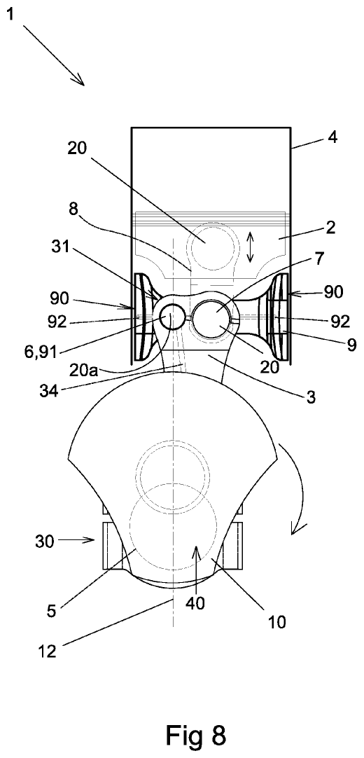

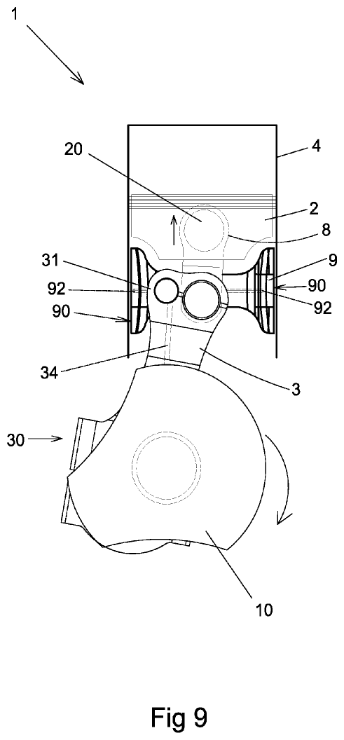

The combustion engine (1) (see FIGS. 5 to 9) of the invention is of the type that comprises at least one hollow cylinder (4) through which a piston (2) travels (also see FIG. 2) in a linear reciprocating motion, coupled by means of a piston rod (3) (also see FIG. 1) to a crankshaft (10), wherein according to the invention, the piston rod (3) comprises (see FIG. 1):
a first hub (5) arranged in its head (30) for coupling with the crankshaft (10),
a second hub (6) arranged in its foot (31), and which is substantially aligned or parallel to the first hub (5) in the longitudinal direction (40) of the cylinder (4) when the crankshaft (10) is in the upper or lower position (see FIGS. 5 and 8, respectively), and
a third hub (7) also arranged in the foot (31) of the piston rod (3), which is offset laterally towards the front with respect to the second hub (6) in the advance direction of the crankshaft (10);
the piston (2) being coupled with the third hub (7) to reach the top dead centre (TDC) when the piston rod (3) is advanced in the direction of rotation of the crankshaft (10), as shown in FIG. 6, wherein the height B is less than the height A, which is the height the piston (2) reaches when the crankshaft is in the upper position (see FIG. 5), and which is also reached when the piston (2) is moving downwards again, as seen in FIG. 7;
comprising a guide (9) (also see FIG. 4) to guide the travel of the piston rod (3) through the cylinder (4) coupled with the second hub (6), and
the piston (2) being coupled with the third hub (7) via a link rod (8) (also see FIG. 3) in order to enable a clearance between the piston (2) and the guide (9) during the reciprocating motion.

More preferably, the link rod (8) is in the shape of a fork, the side branches (80) of which are coupled to the third hub (7) of the piston rod (3), the central branch (81) of which is coupled with the piston (2) through the corresponding bolts (20), since in this manner the piston rod (8) can continue to have an essentially flat configuration and the piston (2) can have its traditional shape in order to enable the coupling thereof by means of the bolt (20), although with shorter skirts (22).

In turn, the guide (9) ideally comprises a body with the general shape of a crown to enable the piston rod (3) to pass through the inside thereof and further surround the walls of the cylinder (4), having at least two curved faces (90) (see FIG. 4) making contact with the walls of the cylinder (4) (which will then be facing one another, as seen in the figures), comprising a fourth hub (91) for coupling with the second hub (6) through an additional bolt (20a). This configuration with two curved faces (90) minimises the contact surfaces with the cylinder (4) as much as possible while maintaining the guide.

To achieve a good lubrication of the curved faces (90) in contact with the walls of the cylinder (4), the invention envisages that the guide (9) preferably comprises oilers (92) to supply oil to said curved faces (90). These oilers (92) are ideally fed by means of a duct (34) that is made through the inside of the piston rod (3) through which pressurised oil runs and flows out at the second hub (6), to which said oilers (92) have access, the additional bolt (20a) in this case comprising an internal duct (23) with accesses (24) facing the duct (34) and oilers (92) to channel the oil to the same.

For optimal operation, wherein the advance of the piston rod has the most favourable angle when the piston (2) is at the top dead centre, the third hub (7) must be arranged (see FIG. 1) in an area comprised in an angle from +60 degrees to −60 degrees with respect to a direction (11) that passes through the centre of the second hub (6) perpendicularly to the imaginary line (12) that joins the centre of the first hub (5) of the head (30) of the piston rod (3) and the centre of the second hub (6) of the foot (31) of the piston rod (3). The best results have been achieved when said area is comprised between +45 degrees and −45 degrees.

Lastly, it must be mentioned that, ideally, the head (30) of the piston rod (3) comprises a detachable section (33) in order to be able to detachably fasten it to the crankshaft (10).

Having sufficiently described the nature of the invention, in addition to the manner of applying it in practice, it must hereby be stated that the aforementioned arrangements indicated and represented in the attached drawings are susceptible to modifications with regard to the detail provided that they do not alter the fundamental principle of the invention.

1. A combustion engine of the type that comprises at least one hollow cylinder, inside of which a piston travels in a linear reciprocating motion, coupled by means of a piston rod to a crankshaft, wherein the piston rod comprises:
a first hub arranged in its head for coupling with the crankshaft,
a second hub arranged in its foot, and which is substantially aligned with or parallel to the first hub in the longitudinal direction of the cylinder when the crankshaft is in the upper or lower position, and
a third hub also arranged in the foot of the piston rod, which is offset laterally towards the front with respect to the second hub in the direction of rotation of the crankshaft;
the piston being coupled with the third hub to reach the top dead center TDC when the piston rod is advanced in the advance direction of the crankshaft,
comprising a guide to guide the travel of the piston rod through the cylinder coupled with the second hub, and
the piston being coupled with the third hub via a link rod in order to enable a clearance between the piston and the guide during the reciprocating motion.

2. The combustion engine according to claim 1, wherein the link rod is in the shape of a fork, the side branches of which are coupled to the third hub of the piston rod, the central branch of which is coupled with the piston through the corresponding bolts.

3. The combustion engine according to claim 1, wherein the guide comprises a body with the general shape of a crown to enable the passage of the piston rod, with at least two curved faces making contact with the walls of the cylinder, comprising a fourth hub for coupling with the second hub through an additional bolt.

4. The combustion engine according to claim 1, wherein the guide comprises oilers to supply oil to the curved faces.

5. The combustion engine according to claim 4, wherein the oilers are fed by means of a duct that is made through the inside of the piston rod through which pressurized oil runs and flows out at the second hub, to which said oilers have access; the additional bolt comprising an internal duct with accesses facing the duct and oilers to channel the oil to the same.

6. The combustion engine according to claim 1, wherein the third hub is arranged in an area comprised in an angle from +60 degrees to −60 degrees with respect to a direction that passes through the center of the second hub perpendicularly to the imaginary line that joins the center of the first hub of the head of the piston rod and the center of the second hub of the foot of the piston rod.

7. The combustion engine according to claim 6, wherein the third hub is arranged in an area comprised in an angle between +45 degrees and −45 degrees with respect to a direction that passes through the center of the second hub perpendicularly to the imaginary line that joins the center of the first hub of the head of the piston rod and the centre center of the second hub of the foot of the piston rod.

8. The combustion engine according to claim 1, wherein the head of the piston rod comprises a detachable section in order to be able to detachably fasten it to the crankshaft.
